(19) United States
(12) Patent Application Publication
(10) Pub. No.: US 2023/0188037 A1
(43) Pub. Date: Jun. 15, 2023

(54) FIXED-FREQUENCY HYSTERETIC DC-DC CONVERTER

(71) Applicant: TEXAS INSTRUMENTS INCORPORATED, Dallas, TX (US)

(72) Inventors: Antonio Priego, Freising (DE); Gerhard Thiele, Dachau (DE); Johann-Erich Bayer, Freising (DE); Mitsuyori Saito, Plano, TX (US); Rida Assaad, Murphy, TX (US); Angelo Pereira, Allen, TX (US)

(21) Appl. No.: 18/065,972

(22) Filed: Dec. 14, 2022

Related U.S. Application Data
(60) Provisional application No. 63/289,662, filed on Dec. 15, 2021.

(51) Int. Cl. H02M 3/158; H02M 1/088

(52) U.S. Cl. CPC H02M 3/158; H02M 1/088

(57) ABSTRACT

In described example, a circuit includes an error amplifier that receives a reference voltage and an output voltage, and generates an error signal. A comparator receives the error signal and a feedback signal, and generates a primary signal. A logic circuit is coupled to an output terminal of the comparator, and receives a clocking pulse. A clocking circuit is coupled to one of a first and a second output terminal of the logic circuit. The clocking circuit receives a clock signal and generates the clocking pulse. A driver circuit is coupled to the logic circuit. A switching circuit, coupled to the driver circuit, receives an input voltage and generates a switching voltage at a switching node. The switching circuit having a first switch coupled to a second switch at the switching node.

### CROSS-REFERENCE TO RELATED APPLICATION

This application claims priority to US Provisional Pat. Application No. 63/289,662 filed Dec. 15, 2021, which is hereby incorporated by reference in its entirety.

### TECHNICAL FIELD

This description relates generally to power converters, and more particularly to hysteretic DC-DC converters.

### BACKGROUND

Power supplies (or DC-DC converters) are required to provide stable regulated supply voltages to digital signal processors (DSPs), digital core supplies, mixed analog circuits, ASICS, memory, and other components. Multiple electronic devices including the battery operated devices, such as mobile phones, tablets, laptops and similar other user devices, typically employ DC-DC converters to provide supply voltages for operation of the internal circuitry. The DC-DC converters convert an input supply voltage to a voltage level suitable for the internal circuit. As electronic devices and circuit designs continue to decrease in size, the need for smaller and more efficient DC-DC converters increases.

The DC-DC converters, in certain automotive applications, are required to provide a fixed switching frequency to an associated electronic device. Also, an electronic device includes multiple integrated circuits such as microprocessors, memory, data converters, which result in high slew rate (or fast) transients in the electronic device. A hysteretic DC-DC converter is a simple topology that provides fast response to load transients. In addition, the hysteretic DC-DC converter is preferred for its small size and lower costs. However, the main disadvantage with the hysteretic DC-DC converter is that its switching frequency varies strongly with operating conditions and with parasitics associated with circuit components.

### SUMMARY

In described example, a circuit includes an error amplifier that receives a reference voltage and an output voltage, and generates an error signal. A comparator receives the error signal and a feedback signal, and generates a primary signal. A logic circuit is coupled to an output terminal of the comparator, and receives a clocking pulse. A clocking circuit is coupled to one of a first and a second output terminal of the logic circuit. The clocking circuit receives a clock signal and generates the clocking pulse. A driver circuit is coupled to the logic circuit. A switching circuit, coupled to the driver circuit, receives an input voltage and generates a switching voltage at a switching node. The switching circuit having a first switch coupled to a second switch at the switching node.

### BRIEF DESCRIPTION OF THE DRAWINGS

FIG. 1 is a schematic of a circuit.

FIG. 2 is a schematic of a circuit, according to an embodiment.

FIG. 3 is a timing diagram illustrating operation of the circuit of FIG. 2, according to an embodiment.

FIG. 4 is a timing diagram illustrating operation of the circuit of FIG. 2, according to an embodiment.

FIG. 5 is a schematic of a circuit, according to an embodiment.

FIG. 6 is a timing diagram illustrating operation of the circuit of FIG. 5, according to an embodiment.

FIG. 7 is a timing diagram illustrating operation of the circuit of FIG. 5, according to an embodiment.

FIG. 8 is a flowchart of a method of operation of a circuit, according to an embodiment.

FIG. 9 illustrates a computing device in accordance with embodiments.

### DETAILED DESCRIPTION OF EXAMPLE EMBODIMENTS

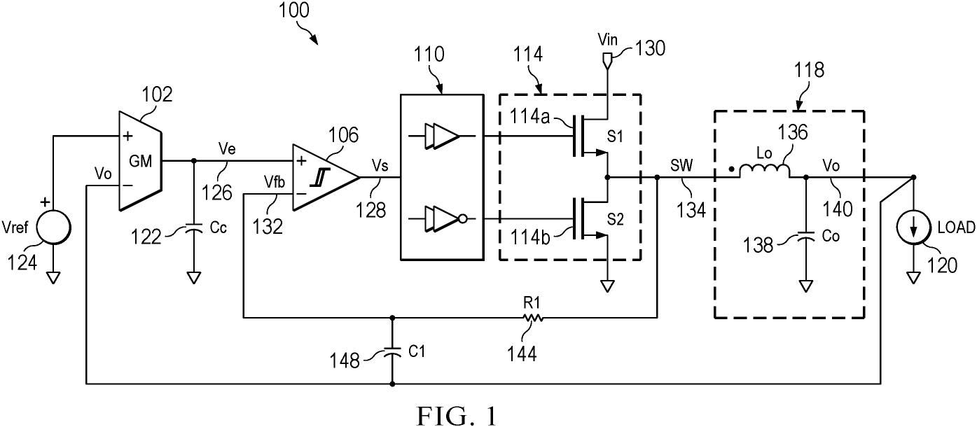

FIG. 1 is a schematic of a circuit 100. The circuit 100 includes an error amplifier GM 102, a comparator 106, a driver circuit 110, a switching circuit 114 and an output filter 118. The error amplifier GM 102 receives a reference voltage Vref 124. The comparator 106 is coupled to the error amplifier GM 102. The driver circuit 110 is coupled to the comparator 106. The switching circuit 114 is coupled to the driver circuit 110. The switching circuit 114 includes a first switch S1 114a and a second switch S2 114b. A gate terminal of each of the first switch S1 114a and the second switch S2 114b is coupled to the driver circuit 110.

A source terminal of the first switch S1 114a in the switching circuit 114 receives an input voltage Vin 130, and a source terminal of the second switch S2 114b is coupled to a ground terminal. A drain terminal of each of the first switch S1 114a and the second switch S2 114b are coupled to a switching node SW 134. The output filter 118 is coupled to the switching circuit 114 through the switching node SW 134.

The output filter 118 includes an inductor Lo 136 and a primary capacitor Co 138. A first terminal of the inductor Lo 136 is coupled to the switching node SW 134 and a second terminal of the inductor Lo 136 is coupled to a first terminal of the primary capacitor Co 138. A second terminal of the primary capacitor Co 138 is coupled to the ground terminal. A load 120 is coupled to the output filter 118.

The circuit 100 also includes a first resistor R1 144 and a first capacitor C1 148. The first resistor R1 144 is coupled to the switching node SW 134 and to the comparator 106. One end of the first capacitor C1 148 is coupled to the first resistor R1 144 and to the comparator 106, and the second end is coupled to the second terminal of the inductor Lo 136. The circuit 100 includes a coupling capacitor Cc 122 whose one end is coupled to the error amplifier GM 102 and to the comparator 106, and whose second end is coupled to the ground terminal.

In operation, the switching circuit 114 receives an input voltage Vin 130 and generates a switching voltage at the switching node SW 134. The switching voltage is provided to the output filter 118 to generate an output voltage Vo 140. The output voltage Vo 140 is provided to the load 120. The output voltage Vo 140 is also provided to the error amplifier GM 102. The error amplifier GM 102 compares the reference voltage Vref 124 and the output voltage Vo 140 to generate an error signal Ve 126. The switching voltage generated at the switching node SW 134 is provided to the first resistor R1 144 and the first capacitor C1 148 to generate a feedback signal Vfb 132.

The comparator 106 compares the error signal Ve 126 and the feedback signal Vfb 132 to generate a secondary signal Vs 128. The secondary signal Vs 128 is provided to the driver circuit 110 which controls the on and off time of the first switch S1 114a and the second switch S2 114b. This keeps the output voltage Vo 140 constant and independent from variations in the input voltage Vin 130. In addition, the circuit 100 has faster transient response characteristics as the circuit 100 responds to any load 120 transient in the same switching cycle. However, a switching frequency of the circuit 100 depends on - (1) characteristics of the output filter 118 particularly the characteristics of the primary capacitor Co 138, (2) the hysteretic response of the comparator 106, and (3) a propagation delay in the comparator 106, the driver circuit 110 and the switching circuit 114 . Thus, the switching frequency varies strongly with changes in the operating conditions. Hence, the switching frequency of the circuit 100 is not fixed. The circuit 100, in one example, uses an adaptive on-timer. This limits the variation in switching frequency but still does not yield fixed frequency.

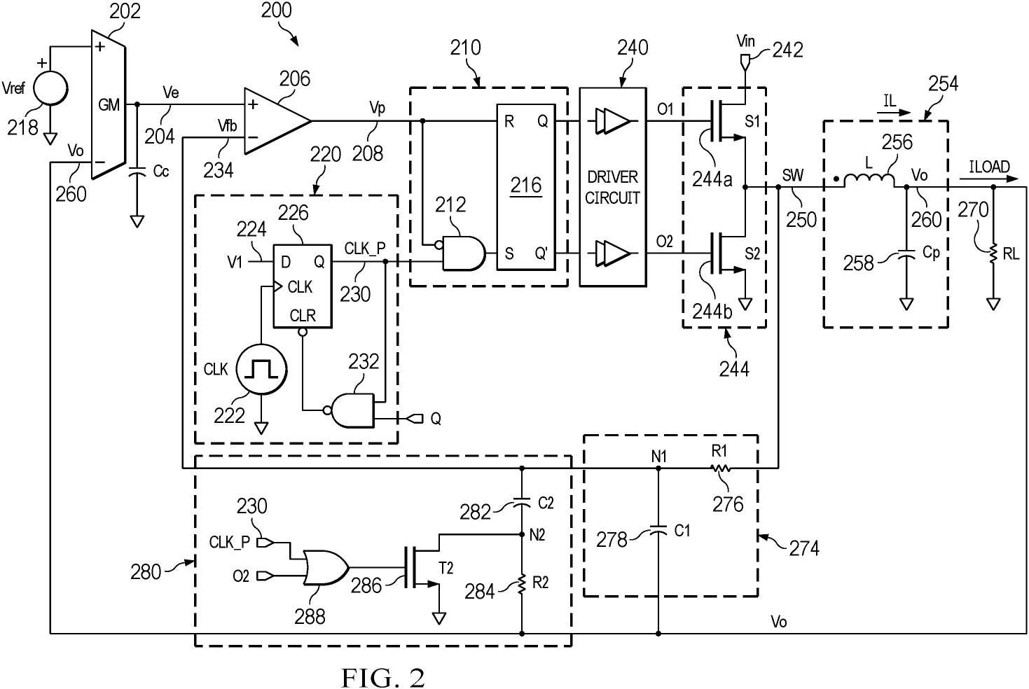

FIG. 2 is a schematic of a circuit 200, according to an embodiment. The circuit 200 includes an error amplifier GM 202, a comparator 206, a logic circuit 210, a clocking circuit 220, a driver circuit 240, a switching circuit 244 and an output filter 254. The error amplifier GM 202 receives a reference voltage Vref 218. The comparator 206 is coupled to an output terminal of the error amplifier GM 202. The logic circuit 210 is coupled to an output terminal of the comparator 206 and to the clocking circuit 220. The logic circuit 210 having a first output terminal and a second output terminal. The clocking circuit 220 includes a first latch 226, and a first gating circuit 232. The first latch 226 receives a clock signal CLK 222 and a first input signal V1 224. The first gating circuit 232 is coupled to the output terminal of the first latch and to the first output terminal of the logic circuit 210.

The logic circuit 210 includes a second gating circuit 212 and a second latch 216. The second gating circuit 212 is coupled to the clocking circuit 220 and to the output terminal of the comparator 206. The second latch 216 is coupled to an output terminal of the second gating circuit 212 and to the output terminal of the comparator 206. A first output terminal of the second latch 216 is the first output terminal of the logic circuit 210, and a second output terminal of the second latch 216 is the second output terminal of the logic circuit 210. The specifically illustrated or disclosed logic in each gating circuit is provided to explain the logical flow, and it is understood, that each of the gating circuit can be a combination of logic gates, flip-flops and other digital logic.

The driver circuit 240 is coupled to the first and the second output terminals of the logic circuit 210. The driver circuit 240 having a first output terminal O1 and a second output terminal O2. The switching circuit 244 is coupled to the driver circuit 240. The switching circuit 244 receives an input voltage Vin 242 and includes a first switch S1 244a and a second switch S2 244b. A gate terminal of the first switch S1 244a is coupled to the first output terminal O1 of the driver circuit 240, and a gate terminal of the second switch S2 244b is coupled to the second output terminal O2 of the driver circuit 240. A source terminal of the first switch S1 244a receives the input voltage Vin 242, and a source terminal of the second switch S2 244b is coupled to a ground terminal. A drain terminal of each of the first switch S1 244a and the second switch S2 244b is coupled to a switching node SW 250.

The output filter 254 is coupled to the switching circuit 244. The output filter 254 includes an inductor L 256 and a primary capacitor Cp 258. A first terminal of the inductor L 256 is coupled to the switching node SW 250, and a second terminal of the inductor L 256 is coupled to one end of the primary capacitor Cp 258. A second end of the primary capacitor Cp 258 is coupled to a ground terminal. In addition, the second terminal of the inductor L 256 is adapted to be coupled to a load RL 270. In one example, the load RL 270 is external to the circuit 200. In another example, the load RL 270 is on the same board as the circuit 200.

The circuit 200 includes a first circuit 274 and a slope-compensation circuit 280. The first circuit includes a first resistor R1 276 and a first capacitor C1 278. One end of the first resistor R1 276 is coupled to the switching node SW 250, and a second end of the first resistor R1 276 is coupled to the comparator 206. One end of the first capacitor C1 278 is coupled to the second end of the first resistor R1 276 and to the comparator 206 at a first node N1. A second end of the first capacitor C1 278 is coupled to the second terminal of the inductor L 256.

The slope-compensation circuit 280 includes a second capacitor C2 282, a second resistor R2 284, a third gating circuit 288 and a second transistor T2 286. One end of the second capacitor C2 282 is coupled to the comparator 206. One end of the second resistor R2 284 is coupled to the second capacitor C2 282 and a second end of the second resistor R2 284 is coupled to the second terminal of the inductor L 256. The third gating circuit 288 is coupled to the second output terminal O2 of the driver circuit 240 and to the clocking circuit 220. A source terminal of the second transistor T2 286 is coupled to a ground terminal, and a drain terminal is coupled to the second capacitor C2 282 and to the second resistor R2 284 at a second node N2. A gate terminal of the second transistor T2 286 is coupled to an output terminal of the third gating circuit 288. The circuit 200 may include one or more conventional components that are not described herein for brevity. Also, each block or component of FIG. 2 may be coupled to conventional components of a system using the circuit 200, which are also not shown in FIG. 2 for brevity.

In operation, the switching circuit 244 receives the input voltage Vin 242 and generates a switching voltage at the switching node SW 250. The output filter 254 receives the switching voltage and generates an output voltage Vo 260. The error amplifier GM 202 receives the reference voltage Vref 218 and the output voltage Vo 260. The error amplifier GM 202 generates an error signal Ve 204 at the output terminal of the error amplifier GM 202. The error amplifier GM 202 improves DC accuracy in regulation of the output voltage Vo 260. The comparator 206 receives the error signal Ve 204 and a feedback signal Vfb 234. The comparator 206 generates a primary signal Vp 208. The clocking circuit 220 generates a clocking pulse CLK_P 230. The logic circuit 210 receives the primary signal Vp 208 and the clocking pulse CLK_P 230. The logic circuit 210 generates a first logic output Q at the first output terminal and a second logic output Q′ at the second output terminal.

The first latch 226 in the clocking circuit 220 receives the clock signal CLK 222 and the first input signal V1 224. In one example, the first latch 226 is a D-flip flop. In another example, the first latch 226 is a digital logic circuit. In yet another example, the first input signal V1 224 is always a logic high signal. The first latch 226 generates the clocking pulse CLK_P 230 at an output terminal of the first latch 226. The first gating circuit 232 receives the clocking pulse CLK_P 230 and the first logic output Q. The first gating circuit 232 generates a clear signal CLR that is provided to the first latch 226. The clear signal CLR resets the first latch 226.

In the logic circuit 210, the second gating circuit 212 receives the primary signal Vp 208 and the clocking pulse CLK_P 230. An output of the second gating circuit 212 is provided to the second latch 216. The second latch 216 also receives the primary signal Vp 208. The second latch 216 generates the first logic output Q and the second logic output Q′. In one example, the second latch 216 is an RS flip flop. In another example, the second latch 216 is a digital logic circuit. The logic circuit 210 drives the driver circuit 240, and the driver circuit 240 activates one of the first switch S1 244a and the second switch S2 244b in the switching circuit 244. The switching circuit 244 generates the switching voltage at the switching node SW 250, and the output filter 254 generates the output voltage Vo 260 from the switching voltage. The output voltage Vo 260 is provided to the load RL 270. The switching voltage generated at the switching node SW 250 and the output voltage Vo 260 are provided to the first circuit 274 and the slope-compensation circuit 280 to generate the feedback signal Vfb 234. The first circuit 274 generates a main-regulation ramp, and the slope-compensation circuit 280 generates a compensation ramp. The compensation ramp and the main-regulation ramp together generate the feedback signal Vfb 234.

When the clock signal CLK 222 transitions from logic low to logic high, the clocking pulse CLK_P 230 is set at logic high. In steady-state mode, the primary signal Vp 208 is at logic low (or 0) when the clocking pulse CLK_P 230 is set at high. Therefore, the second latch 216 is set, in which the first logic output Q is at logic high and the second logic output Q′ is at logic low. The outputs of the logic circuit 210 (Q and Q′) drives the driver circuit 240, which results in the first output terminal O1 at logic high and the second output terminal O2 at logic low. This activates the first switch S1 244a and inactivates the second switch S2 244b. The second transistor T2 286 is also inactivated as the second logic output Q′ is at logic low. A current IL through the inductor L 256 increases. The feedback signal Vfb 234 increases as a ramp with a slope which is a summation of a slope of the main-regulation ramp and a slope of the compensation ramp. The main-regulation ramp is a result of integration of the switching voltage generated at the switching node SW 250 by the first circuit 274. The slope of the main-regulation ramp is a slope of the signal at the first node N1. In one example, the first circuit 274 is a low pass filter with a time constant R1C1. The slope of the main-regulation ramp is defined as:

$${m}_{1} = \frac{{V}_{i n} - {V}_{O}}{{R}_{1} {C}_{1}}$$

As the second transistor T2 286 is inactivated, the second node N2 is pre-biased to 0 volts and connected to the output voltage Vo 260 through the second resistor R2 284. A current Vo/R2 starts to flow into the second capacitor C2 282, and a voltage at the first node N1 ramps with the slope of the compensation ramp , the slope of the compensation ramp is defined as:

$${m}_{a} = \frac{{V}_{O}}{{R}_{2} ⋅ {C}_{1}}$$

Thus, the feedback signal Vfb 234 increases as a ramp with a slope which is a summation of the slope of the main-regulation ramp and the slope of the compensation ramp, which is defined as:

$${m}_{O N} = \frac{{V}_{i n} - {V}_{O}}{{R}_{1} {C}_{1}} + \frac{{V}_{O}}{{R}_{2} {C}_{1}}$$

The primary signal Vp 208 is generated when the feedback signal Vfb 234 is more than the error signal Ve 204. The comparator 206 monitors the feedback signal Vfb 234 and generates the primary signal Vp 208 when the feedback signal Vfb 234 reaches a level of the error signal Ve 204. The primary signal Vp 208 resets the logic circuit 210 which makes the first logic output Q to transition to logic low and the second logic output Q′ to transition to logic high. The outputs of the logic circuit 210 (Q and Q′) drives the driver circuit 240, which results in the first output terminal O1 to transition to logic low and the second output terminal O2 to transition to logic high. This inactivates the first switch S1 244a and activates the second switch S2 244b. The second transistor T2 286 is also activated as the second output terminal O2 is at logic high. The current IL through the inductor L 256 decreases. The feedback signal Vfb 234 decreases as a ramp with a slope which is defined as:

$${m}_{b} = \frac{{V}_{O}}{{R}_{1} {C}_{1}}$$

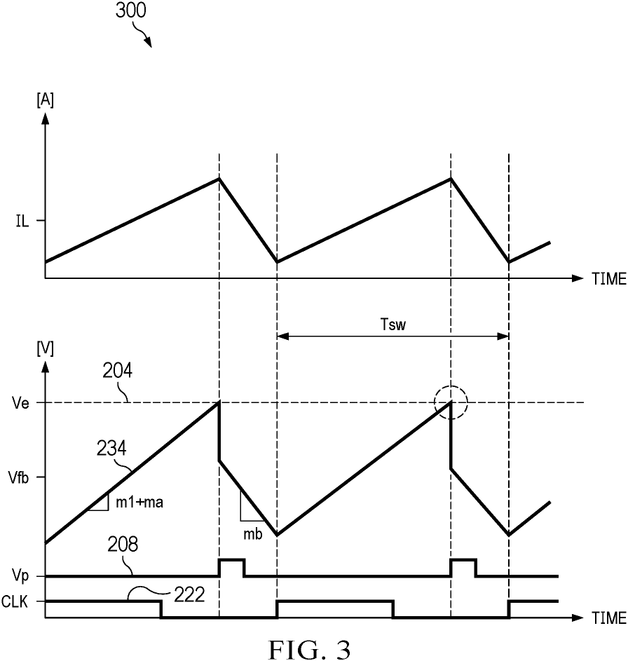

The feedback signal Vfb 234 decreases with a slope mb until the clock signal CLK 222 transitions to logic high. Both the slopes ml and mb are proportional to the slope of the inductor current IL. Thus, the comparator 206 indirectly monitors the inductor current IL, and hence the circuit 200 is functioning as an emulated peak-current control. As in any current control topology operating at a fixed frequency, the slope ma is n times of the slope mb to achieve stability, where n, in one example, is between 0.5 and 1. Both the slopes ma and mb matches over process and temperature variations (for matching values of resistor and capacitors). The provides huge advantage to the circuit 200 over conventional peak-current control topologies. Thus, circuit 200 can be used as a fixed-frequency buck converter with stability over all duty cycles of the clock signal CLK 222. This operation of the circuit 200 is explained in connection with a timing diagram illustrated in FIG. 3. The slope-compensation circuit 280 provides stability to the circuit 200, and avoids any sub-harmonic oscillations in the circuit 200 at certain duty cycles. The main-regulation ramp is a replica of inductor current IL, and thus, the inductor current IL is continuously monitored by the comparator 206. The clocking circuit 220 and the logic circuit 210 supports fast response of the circuit 200 at extreme load RL 270 transients. Also, the circuit 200 is capable of operating at any Vin/Vo operating condition independently of the clock signal CLK 222 duty cycle. The clocking circuit 220 and the logic circuit 210 forces the circuit 200 to operate at a fixed switching frequency in steady state. The switching frequency of the circuit 200 is defined by the clock signal CLK 222, and the switching frequency does not vary with the operating conditions or with the parasitics. The circuit 200 not only maintains the characteristic fast response and small solution size (small primary capacitor Cp 258) of a hysteretic buck converter but also provides fixed frequency operation with no additional regulation loop. The circuit 200 can be stacked to support very high load current requirements in applications such as Infotainment, ADAS, Optical networks, Storage, FPGA and digital cores supplies.

FIG. 3 is a timing diagram 300 illustrating operation of the circuit of FIG. 2, according to an embodiment. The timing diagram 300 is explained in connection with the circuit 200, illustrated in FIG. 2, and provides operation of the circuit in a steady-state mode. When the clock signal CLK 222 transitions from logic low to logic high, , the clocking pulse CLK_P 230 is set at logic high. In steady-state mode, the primary signal Vp 208 is at logic low (or 0) when the clocking pulse CLK_P 230 is set at high. Therefore, the second latch 216 is set, in which, the first logic output Q is at logic high and the second logic output Q′ is at logic low. The outputs of the logic circuit 210 (Q and Q′) drives the driver circuit 240, which results in the first output terminal O1 at logic high and the second output terminal O2 at logic low. This activates the first switch S1 244a and inactivates the second switch S2 244b. The second transistor T2 286 is also inactivated as the second logic output Q′ is at logic low. A current IL through the inductor L 256 increases. The feedback signal Vfb 234 increases as a ramp with a slope which is a summation of a slope of the main-regulation ramp and a slope of the compensation ramp. The main-regulation ramp is a result of integration of the switching voltage generated at the switching node SW 250 by the first circuit 274. The slope of the main-regulation ramp is a slope of the signal at the first node N1. In one example, the first circuit 274 is a low pass filter with a time constant R1C1. The slope of the main-regulation ramp is defined as:

$${m}_{1} = \frac{{V}_{I N} - {V}_{O}}{{R}_{1} {C}_{1}}$$

As the second transistor T2 286 is inactivated, the second node N2 is pre-biased to 0 volts and connected to the output voltage Vo 260 through the second resistor R2 284. A current Vo/R2 starts to flow into the second capacitor C2 282, and a voltage at the first node N1 ramps with the slope of the compensation ramp, the slope of the compensation ramp is defined as:

$${m}_{a} = \frac{{V}_{O}}{{R}_{2} ⋅ {C}_{1}}$$

Thus, the feedback signal Vfb 234 increases as a ramp with a slope which is a summation of the slope of the main-regulation ramp and the slope of the compensation ramp, which is defined as:

$${m}_{O N} = \frac{{V}_{I N} - {V}_{O}}{{R}_{1} {C}_{1}} + \frac{{V}_{O}}{{R}_{2} {C}_{1}}$$

The primary signal Vp 208 is generated when the feedback signal Vfb 234 is more than the error signal Ve 204. The comparator 206 monitors the feedback signal Vfb 234 and generates the primary signal Vp 208 when the feedback signal Vfb 234 reaches a level of the error signal Ve 204. The primary signal Vp 208 resets the logic circuit 210 which makes the first logic output Q to transition to logic low and the second logic output Q′ to transition to logic high. The outputs of the logic circuit 210 (Q and Q′) drives the driver circuit 240, which results in the first output terminal O1 to transition to logic low and the second output terminal O2 to transition to logic high. This inactivates the first switch S1 244a and activates the second switch S2 244b. The second transistor T2 286 is also activated as the second output terminal O2 is at logic high. The current IL through the inductor L 256 decreases. The feedback signal Vfb 234 decreases as a ramp with a slope which is defined as:

$${m}_{b} = \frac{{V}_{O}}{{R}_{1} {C}_{1}}$$

The feedback signal Vfb 234 decreases with a slope mb until the clock signal CLK 222 transitions to logic high. Both the slopes m1 and mb are proportional to the slope of the inductor current IL. Thus, the comparator 206 indirectly monitors the inductor current IL, and hence the circuit 200 is functioning as an emulated peak-current control. As in any current control topology operating at a fixed frequency, the slope ma is n times of the slope mb to achieve stability, where n, in one example, is between 0.5 and 1. Both the slopes ma and mb matches over process and temperature variations (for matching values of resistor and capacitors). The provides huge advantage to the circuit 200 over conventional peak-current control topologies.

Thus, circuit 200 can be used as a fixed-frequency buck converter with stability over all duty cycles of the clock signal CLK 222. The clocking circuit 220 and the logic circuit 210 supports fast response of the circuit 200 at extreme load RL 270 transients. Also, the circuit 200 is capable of operating at any Vin/Vo operating condition independently of the clock signal CLK 222 duty cycle. The clocking circuit 220 and the logic circuit 210 forces the circuit 200 to operate at a fixed switching frequency in steady state. The switching frequency of the circuit 200 is defined by the clock signal CLK 222 whose time period is Tsw as illustrated in the timing diagram 300. The switching frequency of the circuit 200 does not vary with the operating conditions or with the parasitics.

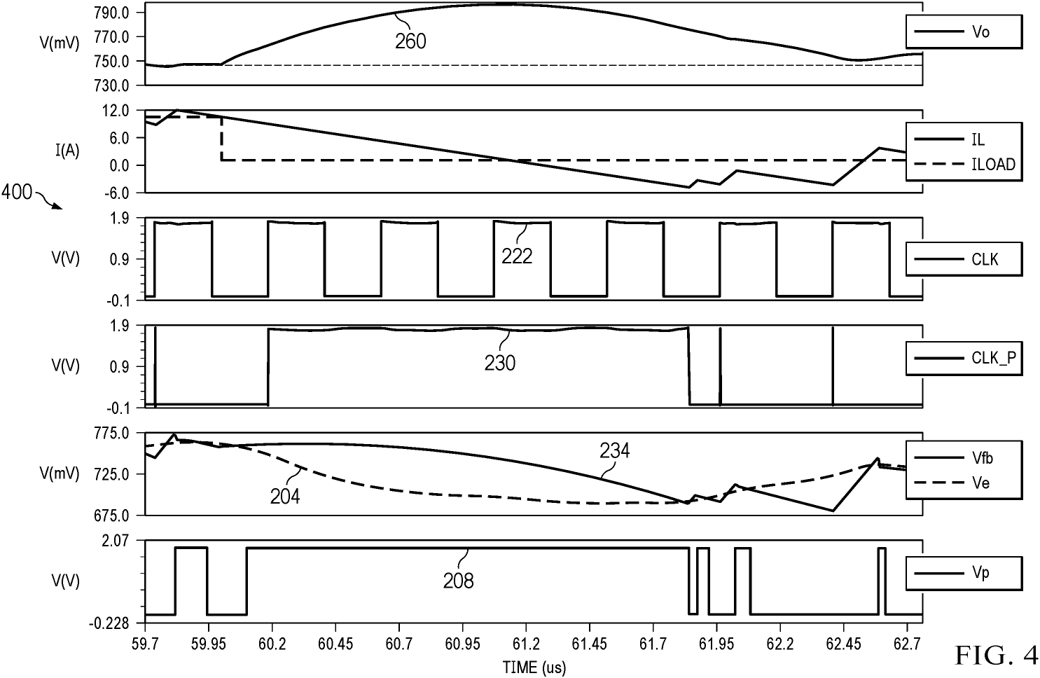

FIG. 4 is a timing diagram 400 illustrating operation of the circuit of FIG. 2, according to an embodiment. The timing diagram 400 is explained in connection with the circuit 200, illustrated in FIG. 2. The timing diagram 400 illustrate operation of the circuit 200 in a transient mode particularly in a peak-current control mode.

As illustrated in the timing diagram, when the load RL 270 changes, a current ILOAD through the load RL 270 steps-down, which results in an overshoot in the output voltage Vo 260. In one example, the current ILOAD through the load RL 270 decreases from 11A to 3A in one microsecond. In another example, the current ILOAD through the load RL 270 decreases below a first threshold. The first threshold is dependent on the application using the circuit 200. In yet another example, the current ILOAD through the load RL 270 does a transition from a high value to 0A. This may occur, in one example, when the load RL 270 is disconnected. In one another example, the current ILOAD transitions from a high value to a low value in a very short duration. A fast reduction in the current ILOAD results in the overshoot in the output voltage Vo 260. The overshoot in the output voltage Vo 260 is AC coupled to the feedback signal Vfb 234 through the second capacitor C2 282. This initially results in increase in the feedback signal Vfb 234. However, the main-regulation ramp through the first circuit 274 will cause the feedback signal Vfb 234 to decrease. The error signal Ve 204 generated by the error amplifier GM 202 decreases to correct the overshoot in the output voltage Vo 260.

The primary signal Vp 208 transitions to logic high and remains in logic high state for the duration when the error signal Ve 204 is less than the feedback signal Vfb 234. An output of the second gating circuit 212 remains at logic low, when the primary signal Vp 208 is at logic high. The first logic output Q of the logic circuit 210 is at logic low, and the second logic output Q′ of the logic circuit 210 is at logic high. As the first logic output Q is at logic low, the first latch 226 cannot be reset. The clocking pulse CLK_P 230 generated during this duration remains at logic high. The second gating circuit 212 block propagation of the logic high clocking pulse CLK_P 230 as the primary signal Vp 208 is at logic high. Thus, the clock signal CLK 222 is masked (or latched in the first latch 226) for the duration when the error signal Ve 204 is less than the feedback signal Vfb 234. The logic circuit 210 drives the driver circuit 240 which activates the second switch S2 244b and inactivates the first switch S1 244a in the switching circuit 244. Hence, the switching node SW 250 is at logic low. Thus, the inductor current IL and the main-regulation ramp will decrease. This results in discharge of the output voltage Vo 260 through the second switch S2 244b. The circuit 200 provides fast response characteristics as priority is given to the primary signal Vp 208 over the clock signal CLK 222. Once the output voltage Vo 260 is at a target level, the error signal Ve 204 becomes greater than the feedback signal Vfb 234. The primary signal Vp 208 transitions to logic low. As the clocking pulse CLK_P 230 is at logic high, it resets the second latch 216 which immediately forces the switching circuit 244 to toggle (activating the first switch S1 244a and inactivating the second switch S2 244b). This ensures fast recovery of regulation loop after a transient.

Thus, the circuit 200 provides fast settling of the output voltage Vo 260 after an extreme transient. The circuit 200 does not compromise stability, as the clock signal CLK 222 is latched during the period when the error signal Ve 204 is less than the feedback signal Vfb 234. In case, the clock signal CLK 222 is not latched, recovery of the clock signal CLK 222 might get delayed. If the output voltage Vo 260 is at the target level, and the clock signal CLK 222 is not recovered, it will result in undershoot of the output voltage Vo 260. The clocking circuit 220 and the logic circuit 210 supports fast response of the circuit 200 at extreme load RL 270 transients.

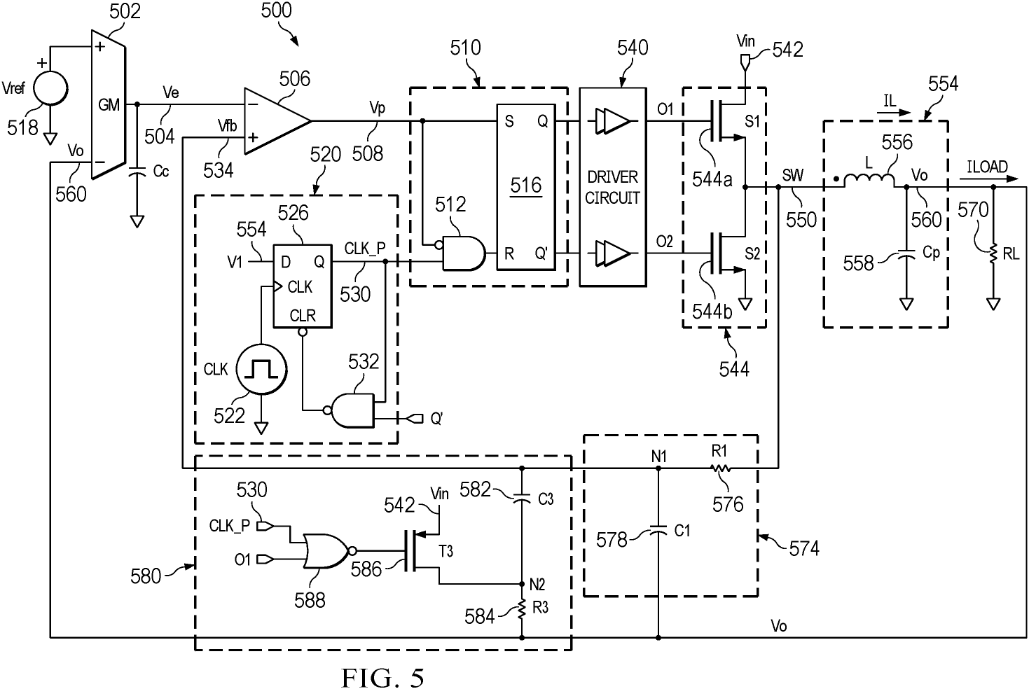

FIG. 5 is a schematic of a circuit 500, according to an embodiment. The circuit 500 includes an error amplifier GM 502, a comparator 506, a logic circuit 510, a clocking circuit 520, a driver circuit 540, a switching circuit 544 and an output filter 554. The error amplifier GM 502 receives a reference voltage Vref 518. The comparator 506 is coupled to an output terminal of the error amplifier GM 502. The logic circuit 510 is coupled to an output terminal of the comparator 506 and to the clocking circuit 520. The logic circuit 510 having a first output terminal and a second output terminal. The clocking circuit 520 includes a first latch 526, and a first gating circuit 532. The first latch 526 receives a clock signal CLK 522 and a first input signal V1 554. The first gating circuit 532 is coupled to the output terminal of the first latch and to the second output terminal of the logic circuit 510.

The logic circuit 510 includes a second gating circuit 512 and a second latch 516. The second gating circuit 512 is coupled to the clocking circuit 520 and to the output terminal of the comparator 506. The second latch 516 is coupled to an output terminal of the second gating circuit 512 and to the output terminal of the comparator 506. A first output terminal of the second latch 516 is the first output terminal of the logic circuit 510, and a second output terminal of the second latch 516 is the second output terminal of the logic circuit 510. The specifically illustrated or disclosed logic in each gating circuit is provided to explain the logical flow, and it is understood, that each of the gating circuit can be a combination of logic gates, flip-flops and other digital logic.

The driver circuit 540 is coupled to the first and the second output terminals of the logic circuit 510. The driver circuit 540 having a first output terminal O1 and a second output terminal O2. The switching circuit 544 is coupled to the driver circuit 540. The switching circuit 544 receives an input voltage Vin 542 and includes a first switch S1 544a and a second switch S2 544b. A gate terminal of the first switch S1 544a is coupled to the first output terminal O1 of the driver circuit 540, and a gate terminal of the second switch S2 544b is coupled to the second output terminal O2 of the driver circuit 540. A source terminal of the first switch S1 544a receives the input voltage Vin 542, and a source terminal of the second switch S2 544b is coupled to a ground terminal. A drain terminal of each of the first switch S1 544a and the second switch S2 544b is coupled to a switching node SW 550.

The output filter 554 is coupled to the switching circuit 544. The output filter 554 includes an inductor L 556 and a primary capacitor Cp 558. A first terminal of the inductor L 556 is coupled to the switching node SW 550, and a second terminal of the inductor L 556 is coupled to one end of the primary capacitor Cp 558. A second end of the primary capacitor Cp 558 is coupled to a ground terminal. In addition, the second terminal of the inductor L 556 is adapted to be coupled to a load RL 570.

The circuit 500 includes a first circuit 574 and a slope-compensation circuit 580. The first circuit includes a first resistor R1 576 and a first capacitor C1 578. One end of the first resistor R1 576 is coupled to the switching node SW 550, and a second end of the first resistor R1 576 is coupled to the comparator 506. One end of the first capacitor C1 578 is coupled to the second end of the first resistor R1 576 and to the comparator 506 at a first node N1. A second end of the first capacitor C1 578 is coupled to the second terminal of the inductor L 556.

The slope-compensation circuit 580 includes a third capacitor C3 582, a third resistor R3 584, a fourth gating circuit 588 and a third transistor T3 586. One end of the third capacitor C3 582 is coupled to the comparator 506. One end of the third resistor R3 584 is coupled to the third capacitor C3 582 and a second end of the third resistor R3 584 is coupled to the second terminal of the inductor L 556. The fourth gating circuit 588 is coupled to the first output terminal O1 of the driver circuit 540 and to the clocking circuit 520. A source terminal of the third transistor T3 586 is coupled to the input voltage Vin 542, and a drain terminal is coupled to the third capacitor C3 582 and to the third resistor R3 584 at a second node N2. A gate terminal of the third transistor T3 586 is coupled to an output terminal of the fourth gating circuit 588. The circuit 500 may include one or more conventional components that are not described herein for brevity. Also, each block or component of FIG. 5 may be coupled to conventional components of a system using the circuit 500, which are also not shown in FIG. 5 for brevity.

In operation, the switching circuit 544 receives the input voltage Vin 542 and generates a switching voltage at the switching node SW 550. The output filter 554 receives the switching voltage and generates an output voltage Vo 560. The error amplifier GM 502 receives the reference voltage Vref 518 and the output voltage Vo 560. The error amplifier GM 502 generates an error signal Ve 504 at the output terminal of the error amplifier GM 502. The error amplifier GM 502 improves DC accuracy in regulation of the output voltage Vo 560. The comparator 506 receives the error signal Ve 504 and a feedback signal Vfb 534. The comparator 506 generates a primary signal Vp 508. The clocking circuit 520 generates a clocking pulse CLK_P 530. The logic circuit 510 receives the primary signal Vp 508 and the clocking pulse CLK_P 530. The logic circuit 510 generates a first logic output Q at the first output terminal and a second logic output Q′ at the second output terminal.

The first latch 526 in the clocking circuit 520 receives the clock signal CLK 522 and the first input signal V1 554. In one example, the first latch 526 is a D-flip flop. In another example, the first latch 526 is a digital logic circuit. In yet another example, the first input signal V1 554 is always a logic high signal. The first latch 526 generates the clocking pulse CLK_P 530 at an output terminal of the first latch 526. The first gating circuit 532 receives the clocking pulse CLK_P 530 and the first logic output Q. The first gating circuit 532 generates a clear signal CLR that is provided to the first latch 526. The clear signal CLR resets the first latch 526.

In the logic circuit 510, the second gating circuit 512 receives the primary signal Vp 508 and the clocking pulse CLK_P 530. An output of the second gating circuit 512 is provided to the second latch 516. The second latch 516 also receives the primary signal Vp 508. The second latch 516 generates the first logic output Q and the second logic output Q′. In one example, the second latch 516 is an RS flip flop. In another example, the second latch 516 is a digital logic circuit. The logic circuit 510 drives the driver circuit 540, and the driver circuit 540 activates one of the first switch S1 544a and the second switch S2 544b in the switching circuit 544. The switching circuit 544 generates the switching voltage at the switching node SW 550, and the output filter 554 generates the output voltage Vo 560 from the switching voltage. The output voltage Vo 560 is provided to the load RL 570. The switching voltage generated at the switching node SW 550 and the output voltage Vo 260 is provided to the first circuit 574 and the slope-compensation circuit 580 to generate the feedback signal Vfb 534. The first circuit 574 generates a main-regulation ramp, and the slope-compensation circuit 580 generates a compensation ramp. The compensation ramp and the main-regulation ramp together generate the feedback signal Vfb 534.

When the clock signal CLK 522 transitions from logic low to logic high, the clocking pulse CLK_P 530 is set at logic high. In steady-state mode, the primary signal Vp 508 is at logic low (or 0) when the clocking pulse CLK_P 530 is set at high. Therefore, the second latch 516 is set, in which , the first logic output Q is at logic low and the second logic output Q′ is at logic high. The outputs of the logic circuit 510 (Q and Q′) drives the driver circuit 540, which results in the first output terminal O1 at logic low and the second output terminal O2 at logic high. This activates the second switch S2 544b and inactivates the first switch S1 544a. The third transistor T3 586 is also activated as the first logic output Q is at logic low. A current IL through the inductor L 556 decreases. The feedback signal Vfb 534 decreases as a ramp with a slope which is a summation of a slope of the main-regulation ramp and a slope of the compensation ramp. The main-regulation ramp is a result of integration of the switching voltage generated at the switching node SW 550 by the first circuit 574. The slope of the main-regulation ramp is a slope of the signal at the first node N1. In one example, the first circuit 574 is a low pass filter with a time constant R1C1. The slope of the main-regulation ramp is defined as:

$${m}_{2} = \frac{{V}_{O}}{{R}_{1} {C}_{1}}$$

As the third transistor T3 586 is activated, the second node N2 is pre-biased to Vin and connected to the output voltage Vo 560 through the third resistor R3 584. A voltage at the first node N1 ramps with the slope of the compensation ramp , the slope of the compensation ramp is defined as:

$${m}_{a} = \frac{V i n - {V}_{O}}{{R}_{3} ⋅ {C}_{1}}$$

Thus, the feedback signal Vfb 534 decreases as a ramp with a slope which is a summation of the slope of the main-regulation ramp and the slope of the compensation ramp, which is defined as:

$${m}_{o f f} = \frac{{V}_{O}}{{R}_{1} {C}_{1}} + \frac{{V}_{i n} - {V}_{O}}{{R}_{3} {C}_{1}}$$

The primary signal Vp 508 is generated when the feedback signal Vfb 534 is less than the error signal Ve 504. The comparator 506 monitors the feedback signal Vfb 534 and generates the primary signal Vp 508 when the feedback signal Vfb 534 reaches a level of the error signal Ve 504. The primary signal Vp 508 resets the logic circuit 510 which makes the first logic output Q to transition to logic high and the second logic output Q′ to transition to logic low. The outputs of the logic circuit 510 (Q and Q′) drives the driver circuit 540, which results in the first output terminal O1 to transition to logic high and the second output terminal O2 to transition to logic low. This activates the first switch S1 544a and inactivates the second switch S2 544b. The third transistor T3 586 is also inactivated as the first output terminal O1 is at logic high. The current IL through the inductor L 556 increases. The feedback signal Vfb 534 increases as a ramp with a slope which is defined as:

$${m}_{1} = \frac{V i n - {V}_{O}}{{R}_{1} {C}_{1}}$$

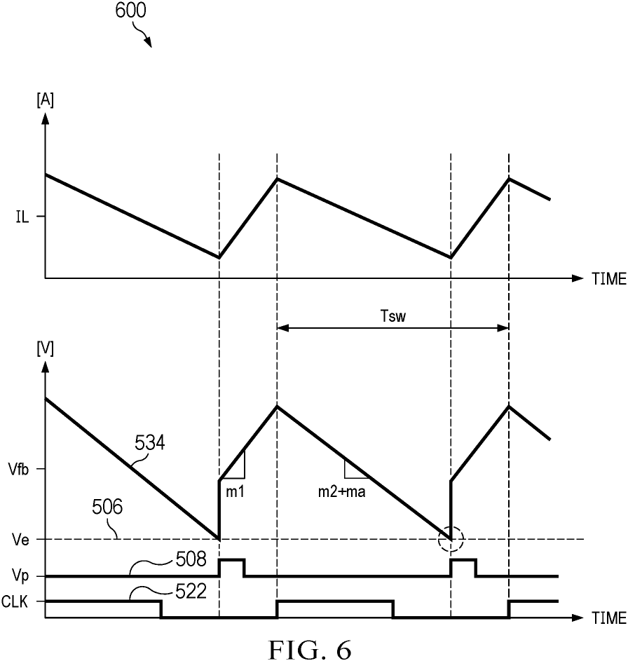

The feedback signal Vfb 534 increases with a slope m1 until the clock signal CLK 522 transitions to logic high. Both the slopes m2 and m1 are proportional to the slope of the inductor current IL. Thus, the comparator 506 indirectly monitors the inductor current IL, and hence the circuit 500 is functioning as an emulated valley-current control. As in any current control topology operating at a fixed frequency, the slope ma is n times of the slope m1 to achieve stability, where n, in one example, is between 0.5 and 1. Both the slopes ma and m1 matches over process and temperature variations (for matching values of resistor and capacitors). Thus, circuit 500 can be used as a fixed-frequency buck converter with stability over all duty cycles of the clock signal CLK 522. This operation of the circuit 500 is explained in connection with a timing diagram illustrated in FIG. 6. The slope-compensation circuit 580 provides stability to the circuit 500, and avoids any sub-harmonic oscillations in the circuit 500 at certain duty cycles. The main-regulation ramp is a replica of inductor current IL, and thus, the inductor current IL is continuously monitored by the comparator 506. The clocking circuit 520 and the logic circuit 510 supports fast response of the circuit 500 at extreme load RL 570 transients. Also, the circuit 500 is capable of operating at any Vin/Vo operating condition independently of the clock signal CLK 522 duty cycle. The clocking circuit 520 and the logic circuit 510 forces the circuit 500 to operate at a fixed switching frequency in steady state. The switching frequency of the circuit 500 is defined by the clock signal CLK 522 and the switching frequency does not vary with the operating conditions or with the parasitics. The circuit 500 not only maintains the characteristic fast response and small solution size (small primary capacitor Cp 258) of a hysteretic buck converter but also provides fixed frequency operation with no additional regulation loop. The circuit 500 can be stacked to support very high load current requirements in applications such as Infotainment, ADAS, Optical networks, Storage, FPGA and digital cores supplies.

FIG. 6 is a timing diagram 600 illustrating operation of the circuit of FIG. 5, according to an embodiment. The timing diagram 600 is explained in connection with the circuit 500, illustrated in FIG. 5, and provides operation of the circuit in a steady-state mode. When the clock signal CLK 522 transitions from logic low to logic high, the clocking pulse CLK_P 530 is set at logic high. In steady-state mode, the primary signal Vp 508 is at logic low (or 0) when the clocking pulse CLK_P 530 is set at high. Therefore, the second latch 516 is set, in which, the first logic output Q is at logic low and the second logic output Q′ is at logic high. The outputs of the logic circuit 510 (Q and Q′) drives the driver circuit 540, which results in the first output terminal O1 at logic low and the second output terminal O2 at logic high. This activates the second switch S2 544b and inactivates the first switch S1 544a. The third transistor T3 586 is also activated as the first logic output Q is at logic low. A current IL through the inductor L 556 decreases. The feedback signal Vfb 534 decreases as a ramp with a slope which is a summation of a slope of the main-regulation ramp and a slope of the compensation ramp. The main-regulation ramp is a result of integration of the switching voltage generated at the switching node SW 550 by the first circuit 574. The slope of the main-regulation ramp is a slope of the signal at the first node N1. In one example, the first circuit 574 is a low pass filter with a time constant R1C1. The slope of the main-regulation ramp is defined as:

$${m}_{2} = \frac{{V}_{O}}{{R}_{1} {C}_{1}}$$

As the third transistor T3 586 is activated, the second node N2 is pre-biased to Vin and connected to the output voltage Vo 560 through the third resistor R3 584. A voltage at the first node N1 ramps with the slope of the compensation ramp , the slope of the compensation ramp is defined as:

$${m}_{a} = \frac{V i n - {V}_{O}}{{R}_{3} ⋅ {C}_{1}}$$

Thus, the feedback signal Vfb 534 decreases as a ramp with a slope which is a summation of the slope of the main-regulation ramp and the slope of the compensation ramp, which is defined as:

$${m}_{o f f} = \frac{{V}_{O}}{{R}_{1} {C}_{1}} + \frac{{V}_{i n} - {V}_{O}}{{R}_{3} {C}_{1}}$$

The primary signal Vp 508 is generated when the feedback signal Vfb 534 is less than the error signal Ve 504. The comparator 506 monitors the feedback signal Vfb 534 and generates the primary signal Vp 508 when the feedback signal Vfb 534 reaches a level of the error signal Ve 504. The primary signal Vp 508 resets the logic circuit 510 which makes the first logic output Q to transition to logic high and the second logic output Q′ to transition to logic low. The outputs of the logic circuit 510 (Q and Q′) drives the driver circuit 540, which results in the first output terminal O1 to transition to logic high and the second output terminal O2 to transition to logic low. This activates the first switch S1 544a and inactivates the second switch S2 544b. The third transistor T3 586 is also inactivated as the first output terminal O1 is at logic high. The current IL through the inductor L 556 increases. The feedback signal Vfb 534 increases as a ramp with a slope which is defined as:

$${m}_{1} = \frac{V i n - {V}_{O}}{{R}_{1} {C}_{1}}$$

The feedback signal Vfb 534 increases with a slope m1 until the clock signal CLK 522 transitions to logic high. Both the slopes m2 and m1 are proportional to the slope of the inductor current IL. Thus, the comparator 506 indirectly monitors the inductor current IL, and hence the circuit 500 is functioning as an emulated valley-current control. As in any current control topology operating at a fixed frequency, the slope ma is n times of the slope m1 to achieve stability, where n, in one example, is between 0.5 and 1. Both the slopes ma and m1 matches over process and temperature variations (for matching values of resistor and capacitors). Thus, circuit 500 can be used as a fixed-frequency buck converter with stability over all duty cycles of the clock signal CLK 522. The slope-compensation circuit 580 provides stability to the circuit 500, and avoids any sub-harmonic oscillations in the circuit 500 at certain duty cycles. The main-regulation ramp is a replica of inductor current IL, and thus, the inductor current IL is continuously monitored by the comparator 506. The clocking circuit 520 and the logic circuit 510 supports fast response of the circuit 500 at extreme load RL 570 transients. Also, the circuit 500 is capable of operating at any Vin/Vo operating condition independently of the clock signal CLK 522 duty cycle. The clocking circuit 520 and the logic circuit 510 forces the circuit 500 to operate at a fixed switching frequency in steady state. The switching frequency of the circuit 500 is defined by the clock signal CLK 522 whose time period is Tsw as illustrated in the timing diagram 600. The switching frequency of the circuit 500 does not vary with the operating conditions or with the parasitics.

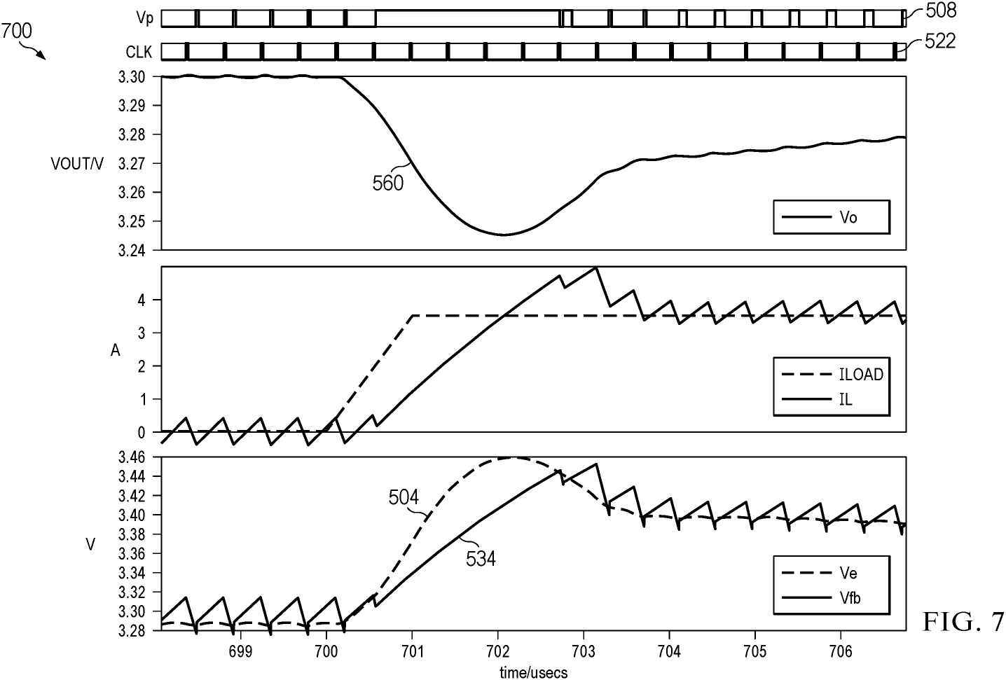

FIG. 7 is a timing diagram 700 illustrating operation of the circuit of FIG. 5, according to an embodiment. The timing diagram 700 is explained in connection with the circuit 500, illustrated in FIG. 5. The timing diagram 700 illustrate operation of the circuit 500 in a transient mode particularly in a valley-current control mode.

As illustrated in the timing diagram, when the load RL 570 changes, a current ILOAD through the load RL 570 steps-up, which results in an undershoot in the output voltage Vo 560. In one example, the current ILOAD through the load RL 570 increases from 3A to 11A in one microsecond. In another example, the current ILOAD through the load RL 570 increases above a second threshold. The second threshold is dependent on the application using the circuit 500. In yet another example, the current ILOAD through the load RL 570 does a transition from 0A to a high value. This may occur, in one example, when the load RL 570 is connected. In one another example, the current ILOAD transitions from a low value to a high value in a very short duration. A fast increase in the current ILOAD results in the undershoot in the output voltage Vo 560. The undershoot in the output voltage Vo 560 is AC coupled to the feedback signal Vfb 534 through the third capacitor C3 582. This initially results in decrease in the feedback signal Vfb 534. However, the main-regulation ramp through the first circuit 574 will cause the feedback signal Vfb 534 to increase. The error signal Ve 504 generated by the error amplifier GM 502 increases to correct the undershoot in the output voltage Vo 560.

The primary signal Vp 508 transitions to logic high and remains in logic high state for the duration when the error signal Ve 504 is greater than the feedback signal Vfb 534. An output of the second gating circuit 512 remains at logic low, when the primary signal Vp 208 is at logic high. The first logic output Q of the logic circuit 510 is at logic high, and the second logic output Q′ of the logic circuit 510 is at logic low. As the second logic output Q′ is at logic low, the first latch 526 cannot be reset. The clocking pulse CLK_P 530 generated during this duration remains at logic high. The second gating circuit 512 block propagation of the logic high clocking pulse CLK_P 530 as the primary signal Vp 508 is at logic high. Thus, the clock signal CLK 522 is masked (or latched in the first latch 526) for the duration when the error signal Ve 504 is greater than the feedback signal Vfb 534. The logic circuit 510 drives the driver circuit 540 which activates the first switch S1 544a and inactivates the second switch S2 544b in the switching circuit 544. Hence, the switching node SW 550 is at logic high. Thus, the inductor current IL and the main-regulation ramp will increase. This results in increase of the output voltage Vo 560 through the first switch S1 544a. The circuit 500 provides fast response characteristics as priority is given to the primary signal Vp 508 over the clock signal CLK 522. Once the output voltage Vo 560 is at a target level, the error signal Ve 504 becomes less than the feedback signal Vfb 534. The primary signal Vp 508 transitions to logic low. As the clocking pulse CLK_P 530 is at logic high, it resets the second latch 516 which immediately forces the switching circuit 544 to toggle (inactivating the first switch S1 244a and activating the second switch S2 244b). This ensures fast recovery of regulation loop after a transient.

Thus, the circuit 500 provides fast settling of the output voltage Vo 560 after an extreme transient. The circuit 500 does not compromise stability, as the clock signal CLK 522 is latched during the period when the error signal Ve 504 is greater than the feedback signal Vfb 534. In case, the clock signal CLK 522 is not latched, recovery of the clock signal CLK 522 might get delayed. If the output voltage Vo 560 is at the target level, and the clock signal CLK 522 is not recovered, it will result in overshoot of the output voltage Vo 560. The clocking circuit 520 and the logic circuit 510 supports fast response of the circuit 500 at extreme load RL 570 transients.

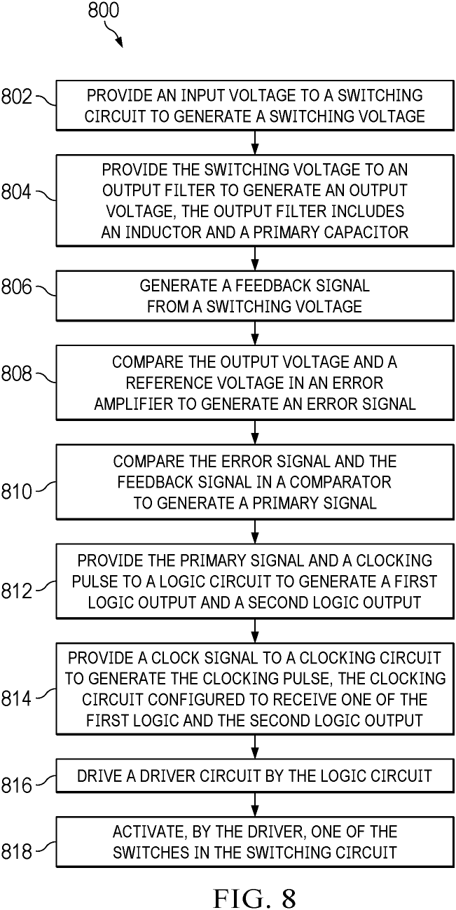

FIG. 8 is a flowchart of a method of operation of a circuit, according to an embodiment. The flowchart 800 is described in connection with the circuit 200 of FIG. 2. The flowchart starts at step 802 and ends at step 818. At step 802, an input voltage is provided to a switching circuit to generate a switching voltage. In circuit 200, for example, the switching circuit 244 receives the input voltage Vin 242 and generates a switching voltage at the switching node SW 250. The switching circuit 244 includes a first switch S1 244a and a second switch S2 244b. At step 804, the switching voltage is provided to an output filter to generate an output voltage. The output filter includes an inductor and a primary capacitor. The output filter 254, in circuit 200, is coupled to the switching circuit 244. The output filter 254 includes an inductor L 256 and a primary capacitor Cp 258. The output filter 254 receives the switching voltage and generates an output voltage Vo 260.

At step 806, a feedback signal is generated from the switching voltage. In circuit 200, the switching voltage generated at the switching node SW 250 and the output voltage Vo 260 are provided to the first circuit 274 and the slope-compensation circuit 280 to generate the feedback signal Vfb 234. At step 808, the output voltage and a reference voltage are compared in an error amplifier to generate an error signal, and the error signal and the feedback signal are compared in a comparator to generate a primary signal, at step 810. In circuit 200, the error amplifier GM 202 receives the reference voltage Vref 218 and the output voltage Vo 260. The error amplifier GM 202 generates an error signal Ve 204 at the output terminal of the error amplifier GM 202. The error amplifier GM 202 improves DC accuracy in regulation of the output voltage Vo 260. The comparator 206 receives the error signal Ve 204 and a feedback signal Vfb 234. The comparator 206 generates a primary signal Vp 208.

At step 812, the primary signal and a clocking pulse are provided to a logic circuit. The logic circuit generates a first logic output and a second logic output. In circuit 200, the logic circuit 210 receives the primary signal Vp 208 and a clocking pulse CLK_P 230. The logic circuit 210 generates a first logic output Q at the first output terminal and a second logic output Q′ at the second output terminal. At step 814, a clock signal is provided to a clocking circuit to generate the clocking pulse. The clocking circuit receives one of the first logic and the second logic output. The clocking circuit 220, in the circuit 200, generates the clocking pulse CLK_P 230. The clocking circuit 220 includes a first latch 226, and a first gating circuit 232. The first latch 226 receives a clock signal CLK 222 and a first input signal V1 224. The first gating circuit 232 is coupled to the output terminal of the first latch 226 and to the first output terminal of the logic circuit 210.

At step 816, the logic circuit drives a driver circuit, and the driver activates one of the switches in the switching circuit, at step 818. In circuit 200, the logic circuit 210 drives the driver circuit 240, and the driver circuit 240 activates one of the first switch S1 244a and the second switch S2 244b in the switching circuit 244.

The method of flowchart 800 enables a circuit or DC-DC converter to support fast response at extreme load transients. Also, the circuit 200 is capable of operating at any Vin/Vo operating condition independently of the clock duty cycle. The method of flowchart 800 provides the clocking circuit and the logic circuit, both of which makes a DC-DC converter to operate at a fixed switching frequency.

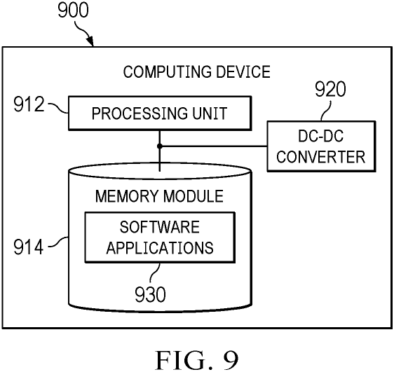

FIG. 9 illustrates a computing device 900 in accordance with embodiments. For example, the computing device 900 is, or is incorporated into, or is coupled (e.g., connected) to an electronic system, such as a computer, electronics control “box” or display, communications equipment (including transmitters or receivers), or any type of electronic system operable to process information.

In some embodiments, the computing device 900 includes a megacell or a system-on-chip (SoC), which includes control logic such as a processing unit 912, a memory module 914 (e.g., random access memory (RAM)). The processing unit 912 can be, for example, a CISC-type (complex instruction set computing) CPU, RISC-type CPU (reduced instruction set computing), MCU-type (microcontroller unit), or a digital signal processor (DSP). The memory module 914 (which can be memory such as on-processor cache, off-processor cache, RAM, flash memory, or disk storage) stores one or more software applications 930 (e.g., embedded applications) that, when executed by the processing unit 912, perform any suitable function associated with the computing device 900.

The processing unit 912 includes memory and logic that store information frequently accessed from the memory module 914. The computing device 900, in one example, is controlled by a user using a UI (user interface), which provides information to and receives information from the user during the execution the software application 930. The information is provided to the user via a display, indicator lights, a speaker, vibrations, and the like. The information is received from the user via audio and/or video inputs (using, for example, voice or image recognition), and electrical and/or mechanical devices such as keypads, switches, proximity detectors, gyros, accelerometers, and the like.

The computing device can be coupled to network devices which can include any device (such as test equipment) capable of point-to-point and/or networked communications with the computing device 900. The computing device 900 is often coupled to peripherals and/or computing devices, including tangible, non-transitory media (such as flash memory) and/or cabled or wireless media. These and other input and output devices are selectively coupled to the computing device 900 by external devices using wireless or cabled connections. The memory module 914 is accessible, such as by the networked devices. The processing unit 912, and the memory module 914 are also optionally coupled to an external power supply (not shown), which is configured to receive power from a power source (such as a battery, solar cell, “live” power cord, inductive field, fuel cell, capacitor, and the like).

The computing device 900 also includes a power supply which includes power generating and control components for generating power to enable the computing device 900 to execute the software application 930. In at least one example, the power supply has one or more independently controllable power switches, each of which can supply power at various voltages to various components of the computing device 900. The power supply is optionally in the same physical assembly as computing device 900, or is external to the computing device 900. The computing device 900 optionally operates in various power-saving modes (such as a sleep mode), so individual voltages are supplied (and/or turned off) according to a selected power-saving mode and the various components arranged within a specific power domain.

The computing device 900 includes a DC-DC converter 920. The DC-DC converter 920 is similar, in connection and operation, to the circuit 200 of FIG. 2 or to the circuit 500 of FIG. 5. In one example, the computing device 900 has both circuit 200 and circuit 500 as DC-DC converters. In another example, the computing device switches between circuit 200 and circuit 500 depending on mode of operation. In yet another example, the computing device 900 includes a DC-DC converter that is capable of operating as circuit 200 during peak-current control mode and as circuit 500 during valley-current control mode. The DC-DC converter is capable of providing fixed frequency operation along with faster response time during load transients.

In this description, unless otherwise stated, “about,” “approximately” or “substantially” preceding a parameter means being within +/- 10 percent of that parameter. The terms logic high, in one example, represents logic 1, and logic low represents logic 0. In another example, logic high is at a voltage level greater than that of a voltage level of logic low. In yet another example, logic high represents digital logic high and logic low represents digital logic low. Modifications are possible in the described embodiments, and other embodiments are possible, within the scope of the claims.

What is claimed is:

1. A circuit comprising:
an error amplifier having first and second input terminals, in which the first input terminal is configured to receive a reference voltage, and the second input terminal is configured to receive an output voltage, and an error signal is generated at an output terminal of the error amplifier;
a comparator coupled to the output terminal of the error amplifier, the comparator configured to receive the error signal and a feedback signal and configured to generate a primary signal;
a logic circuit having a first input terminal and a second input terminal, the first input terminal configured to be coupled to an output terminal of the comparator, and the second input terminal configured to receive a clocking pulse;
a clocking circuit coupled to one of a first and a second output terminal of the logic circuit, the clocking circuit configured to receive a clock signal and configured to generate the clocking pulse;
a driver circuit coupled to the first and the second output terminals of the logic circuit, and having a first output terminal and a second output terminal; and
a switching circuit configured to receive an input voltage and configured to generate a switching voltage at a switching node, the switching circuit having a first switch coupled to a second switch at the switching node, the first switch is coupled to the first output terminal of the driver circuit and the second switch is coupled to the second output terminal of the driver circuit.

2. The circuit of claim 1 further comprising an output filter coupled to the switching circuit, the output filter configured to receive the switching voltage and configured to generate the output voltage.

3. The circuit of claim 2, wherein the output filter further comprises:
an inductor having first and second terminals, the first terminal is coupled to the switching node, and the output voltage is configured to be generated at the second terminal of the inductor; and
a primary capacitor whose one end is coupled to the second terminal of the inductor and whose second end is coupled to a ground terminal, and the second terminal of the inductor is adapted to be coupled to a load.

4. The circuit of claim 3, wherein the second input terminal of the error amplifier is coupled to the second terminal of the inductor in the output filter.

5. The circuit of claim 4, wherein the clocking circuit further comprises:
a first latch configured to receive the clock signal and a first input signal, and configured to generate the clocking pulse; and
a first gating circuit coupled to an output terminal of the first latch and to one of the first and the second output terminals of the logic circuit, the first gating circuit configured to provide a clear signal to the first latch.

6. The circuit of claim 5, wherein the logic circuit further comprises:
a second gating circuit coupled to the clocking circuit and to the output terminal of the comparator; and
a second latch whose input terminals are coupled to an output terminal of the second gating circuit and to the output terminal of the comparator, and output terminals of the second latch are coupled to the first and the second output terminals of the logic circuit.

7. The circuit of claim 6 further comprising a first circuit, the first circuit having:
a first resistor whose one end is coupled to the switching node of the switching circuit and whose second end is coupled to the comparator; and
a first capacitor whose one end is coupled to the second end of the first resistor and to the comparator and whose second end is configured to receive the output voltage.

8. The circuit of claim 7 further comprising a slope-compensation circuit, the slope-compensation circuit having:
a second capacitor coupled to the comparator;
a second resistor whose one end is coupled to the second capacitor and whose second end is configured to receive the output voltage;
a third gating circuit coupled to the second output terminal of the driver circuit and configured to receive the clocking pulse; and
a second transistor having source and drain terminals, the source terminal is configured to be coupled to a ground terminal and the drain terminal is coupled to the second capacitor and to the second resistor, a gate terminal of the second transistor is coupled to an output terminal of the third gating circuit.

9. The circuit of claim 7 further comprising a slope-compensation circuit, the slope-compensation circuit having:
a third capacitor coupled to the comparator;
a third resistor whose one end is coupled to the third capacitor and whose second end is configured to receive the output voltage;
a fourth gating circuit coupled to the first output terminal of the driver circuit and configured to receive the clocking pulse; and
a third transistor having source and drain terminals, the source terminal is configured to receive the input voltage and the drain terminal is coupled to the third capacitor and to the third resistor, a gate terminal of the third transistor is coupled to an output terminal of the fourth gating circuit.

10. The circuit of claim 8, wherein when the clock signal transitions from a logic low to a logic high:
the clocking pulse is set at logic high;
a first logic output of the logic circuit is at logic high, and a second logic output of the logic circuit is at logic low;
the first switch is activated and the second switch is inactivated;
the second transistor is inactivated;
a current through the inductor increases;
the feedback signal increases as a ramp with a slope which is a summation of a slope of a main-regulation ramp and a slope of a compensation ramp, wherein the slope of the main-regulation ramp is proportional to a ratio of a difference in the input voltage and the output voltage and a product of the first resistor and the first capacitor, and the slope of the compensation ramp is proportional to a ratio of the output voltage and a product of the second resistor and the first capacitor;
the primary signal is generated at the output terminal of the comparator when the feedback signal is more than the error signal; and
the primary signal resets the logic circuit.

11. The circuit of claim 10, wherein when the primary signal resets the logic circuit:
the first logic output of the logic circuit is at logic low, and the second logic output of the logic circuit is at logic high;
the first switch is inactivated and the second switch is activated;
the second transistor is activated;
a current through the inductor decreases; and
the feedback signal decreases as a ramp with a slope which is proportional to a ratio of the output voltage and the product of the first resistor and the first capacitor.

12. The circuit of claim 11, wherein when a current through the load decreases from a high value to a low value:
the error signal is generated at the output terminal of the error amplifier;
the primary signal transitions to a logic high when the error signal is less than the feedback signal, the primary signal remains in the logic high state during a time when the error signal is less than the feedback signal;
the clocking circuit configured to generate the clocking pulse, the clocking pulse blocked by the second gating circuit;
the logic circuit drives the driver circuit when the primary signal is at logic high; and
the driver activates the second switch in the switching circuit and inactivates the first switch in the switching circuit.

13. The circuit of claim 9, wherein when the current through the load increases from a low value to a high value:
the error signal is generated at the output terminal of the error amplifier;
the primary signal transitions to logic high when the error signal is greater than the feedback signal, the primary signal remains in the logic high state during a time when the error signal is greater than the feedback signal;
the clocking circuit configured to generate the clocking pulse, the clocking pulse blocked by the second gating circuit;
the logic circuit drives the driver circuit when the primary signal is at logic high; and
the driver activates the first switch in the switching circuit and inactivates the second switch in the switching circuit.

14. A method of operating a DC-DC converter comprising:
providing an input voltage to a switching circuit to generate a switching voltage;
providing the switching voltage to an output filter to generate an output voltage, the output filter includes an inductor and a primary capacitor, the inductor is adapted to be coupled to a load;
generating a feedback signal from the switching voltage and the output voltage;
comparing the output voltage and a reference voltage in an error amplifier to generate an error signal;
comparing the error signal and the feedback signal in a comparator to generate a primary signal;
providing the primary signal and a clocking pulse to a logic circuit to generate a first logic output and a second logic output;
providing a clock signal to a clocking circuit to generate the clocking pulse, the clocking circuit configured to receive one of the first logic output and the second logic output;
driving a driver circuit by the logic circuit; and
activating, by the driver circuit, one of a first switch and a second switch in the switching circuit.

15. The method of claim 14, wherein generating the clocking pulse further comprises:
providing the clock signal and a first input signal to a first latch to generate the clocking pulse; and
generating a clear signal from the clocking pulse and one of the outputs of the logic circuit, the clear signal is provided to the first latch.

16. The method of claim 14, wherein generating the first logic output and the second logic output further comprises:
providing the primary signal and the clocking pulse to a second gating circuit; and
providing the primary signal and an output of the second gating circuit to a second latch.

17. The method of claim 14, wherein generating the feedback signal further comprises providing the switching voltage and the output voltage to a first circuit and a slope-compensation circuit, the first circuit includes a first resistor and a first capacitor, and the slope-compensation circuit includes a second resistor, a second capacitor, a third gating circuit and a second transistor.

18. The method of claim 17, wherein when the clock signal transitions to from a logic low to a logic high:
transitioning the first logic output to a logic high and the second logic output to a logic low;
activating the first switch and inactivating the second switch;
inactivating the second transistor;
increasing the feedback signal when a current through the inductor increases, the feedback signal is increased as a ramp with a slope which is a summation of a slope of a main-regulation ramp and a slope of a compensation ramp, wherein the slope of the main-regulation ramp is proportional to a ratio of a difference in the input voltage and the output voltage and a product of the first resistor and the first capacitor, and the slope of the compensation ramp is proportional to a ratio of the output voltage and a product of the second resistor and the first capacitor;
generating the primary signal at an output terminal of the comparator when the feedback signal is more than the error signal; and
resetting the logic circuit by the primary signal.

19. The method of claim 18, wherein resetting the logic circuit further comprises:
transitioning the first logic output to a logic low and the second logic output to a logic high;
inactivating the first switch and activating the second switch;
activating the second transistor; and
decreasing the feedback signal when the current through the inductor decreases, the feedback signal is decreased as a ramp with a slope which is proportional to a ratio of the output voltage and the product of the first resistor and the first capacitor.

20. The method of claim 19, wherein when a current through the load decreases from a high value to a low value:
generating the error signal at the output terminal of the error amplifier;
generating the primary signal as a logic high signal when the error signal is less than the feedback signal the primary signal remains in the logic high state during a time when the error signal is less than the feedback signal;
generating the clocking pulse which transitions to logic high, the clocking pulse is blocked by the logic circuit;
driving the driver circuit by the logic circuit when the primary signal is at logic high; and
activating the second switch in the switching circuit and inactivating the first switch in the switching circuit.

21. The method of claim 19, wherein when the current through the load increases from a low value to a high value:
generating the error signal at the output terminal of the error amplifier;
generating the primary signal as a logic high signal when the error signal is greater than the feedback signal, the primary signal remains in the logic high state during a time when the error signal is greater than the feedback signal;
generating the clocking pulse which transitions to logic high, the clocking pulse is blocked by the logic circuit;
driving the driver circuit by the logic circuit when the primary signal is at logic high; and
activating the first switch in the switching circuit and inactivating the second switch in the switching circuit.

22. A computing device comprising:
a processing unit;
a memory module coupled to the processing unit; and
a DC-DC converter coupled to the processing unit and the memory module, the DC-DC converter further comprising:
an error amplifier having first and second input terminals, in which the first input terminal is configured to receive a reference voltage, and the second input terminal is configured to receive an output voltage, and an error signal is generated at an output terminal of the error amplifier;
a comparator coupled to the output terminal of the error amplifier, the comparator configured to receive the error signal and a feedback signal and configured to generate a primary signal;
a logic circuit having a first input terminal and a second input terminal, the first input terminal configured to be coupled to an output terminal of the comparator, and the second input terminal configured to receive a clocking pulse;
a clocking circuit coupled to one of a first and a second output terminal of the logic circuit, the clocking circuit configured to receive a clock signal and configured to generate the clocking pulse;
a driver circuit coupled to the first and the second output terminals of the logic circuit, and having a first output terminal and a second output terminal; and
a switching circuit configured to receive an input voltage and configured to generate a switching voltage at a switching node, the switching circuit having a first switch coupled to a second switch at the switching node, the first switch is coupled to the first output terminal of the driver circuit and the second switch is coupled to the second output terminal of the driver circuit.
